(19) United States
(12) Patent Application Publication
(10) Pub. No.: US 2019/0308862 A1
(43) Pub. Date: Oct. 10, 2019

(54) AUXILIARY HYDRAULIC CIRCUIT FILTERING SYSTEMS AND METHODS

(71) Applicant: THE RAYMOND CORPORATION, Greene, NY (US)

(72) Inventor: Erik C. Tracy, Johnson City, NY (US)

(21) Appl. No.: 16/377,997

(22) Filed: Apr. 8, 2019

Related U.S. Application Data
(60) Provisional application No. 62/653,902, filed on Apr. 6, 2018.

(51) Int. Cl. B66F 9/22; B66F 17/00

(52) U.S. Cl. CPC B66F 9/22; F15B 2211/205; B66F 17/003

(57) ABSTRACT

The present disclosure provides a hydraulic system for a material handling vehicle. The hydraulic system includes a reservoir tank, a pump configured to draw fluid from the reservoir tank, and an auxiliary circuit having an auxiliary filter. The auxiliary circuit is in fluid communication with one or more auxiliary functions that are configured to receive fluid from the pump and return fluid to the reservoir tank. When the one of the one or more auxiliary functions is commanded, fluid flow is provided from the pump to the reservoir tank through the auxiliary filter.

### CROSS-REFERENCES TO RELATED APPLICATIONS

The present application is based on, claims priority to, and incorporates herein by reference in its entirety U.S. Provisional Patent Application No. 62/653,902, filed on Apr. 6, 2018, and entitled “Auxiliary Hydraulic Circuit Filtering Systems and Methods.”

### STATEMENT REGARDING FEDERALLY SPONSORED RESEARCH

Not Applicable.

### BACKGROUND

Material handling vehicles typically include hydraulic systems with filters that continuously filter hydraulic fluid during vehicle operation. In some applications, a filter is placed in the primary hydraulic flow path to continuously filter hydraulic fluid.

### BRIEF SUMMARY

The present disclosure relates generally to hydraulic systems and, more specifically, to hydraulic filtering systems and methods on material handling vehicles.

In one aspect, the present disclosure provides a hydraulic system for a material handling vehicle. The hydraulic system includes a reservoir tank, a pump configured to draw fluid from the reservoir tank, and an auxiliary circuit having an auxiliary filter. The auxiliary circuit is in fluid communication with one or more auxiliary functions that are configured to receive fluid from the pump and return fluid to the reservoir tank. When the one of the one or more auxiliary functions is commanded, fluid flow is provided from the pump to the reservoir tank through the auxiliary filter.

In one aspect, the present disclosure provides a hydraulic system for a material handling vehicle. The hydraulic system includes a reservoir tank and an auxiliary circuit having an auxiliary filter, an auxiliary pump, an auxiliary control valve, a bypass passage, and a bypass solenoid arranged on the bypass passage. The auxiliary control valve is configured to selectively provide fluid communication between the auxiliary pump, the reservoir tank, and one or more auxiliary functions. The bypass solenoid is configured to selectively provide or inhibit fluid communication along the bypass passage. When the auxiliary pump is activated to provide fluid flow and the bypass solenoid inhibits fluid communication along the bypass passage, fluid flow is provided from the auxiliary pump to the reservoir tank through the auxiliary pump.

In one aspect, the present disclosure provides a hydraulic system for a material handling vehicle. The hydraulic system includes a reservoir tank, a primary circuit having a primary pump configured to provide fluid flow to one or more primary functions, and an auxiliary circuit having an auxiliary filter. The auxiliary circuit is in fluid communication with one or more auxiliary functions. The hydraulic system further includes an auxiliary supply line configured to provide fluid communication between the primary pump and the auxiliary circuit. When one of the one or more auxiliary functions is commanded, fluid flow is provided from the primary pump to the reservoir tank through the auxiliary filter.

The foregoing and other aspects and advantages of the disclosure will appear from the following description. In the description, reference is made to the accompanying drawings which form a part hereof, and in which there is shown by way of illustration a preferred configuration of the disclosure. Such configuration does not necessarily represent the full scope of the disclosure, however, and reference is made therefore to the claims and herein for interpreting the scope of the disclosure.

### BRIEF DESCRIPTION OF DRAWINGS

The invention will be better understood and features, aspects and advantages other than those set forth above will become apparent when consideration is given to the following detailed description thereof. Such detailed description makes reference to the following drawings.

FIG. 1 is a pictorial view of a material handling vehicle in accordance with aspects of the present disclosure.

FIG. 2 is a schematic illustration of an exemplary hydraulic system configured to provide selective filtering according to aspects of the present disclosure.

FIG. 3 is a schematic illustration of an auxiliary circuit of the hydraulic system of FIG. 2.

FIG. 4 is a schematic illustration of the auxiliary circuit of FIG. 2 including a bypass solenoid.

FIG. 5 is a schematic illustration of an exemplary hydraulic system configured to provide selective filtering according to another aspect of the present disclosure.

FIG. 6 is a schematic illustration of the hydraulic system of FIG. 5 including a bypass solenoid.

### DETAILED DESCRIPTION

Before any aspects of the invention are explained in detail, it is to be understood that the invention is not limited in its application to the details of construction and the arrangement of components set forth in the following description or illustrated in the following drawings. The invention is capable of other aspects and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

The use of the terms “downstream” and “upstream” herein are terms that indicate direction relative to the flow of a fluid. The term “downstream” corresponds to the direction of fluid flow, while the term “upstream” refers to the direction opposite or against the direction of fluid flow.

It is also to be appreciated that material handling vehicles (MHVs) are designed in a variety of configurations to perform a variety of tasks. Although the MHV described herein is shown by way of example as a reach truck, it will be apparent to those of skill in the art that the present invention is not limited to vehicles of this type, and can also be provided in various other types of MHV configurations, including for example, orderpickers, swing reach vehicles, and any other lift vehicles. The various selective filtration configurations disclosed herein are suitable for any of driver controlled, pedestrian controlled, remotely controlled, and autonomously controlled material handling vehicles.

Generally, conventional hydraulic systems on material handling vehicles utilize a filter in the primary flow path, which introduces pressure losses into the hydraulic system regardless of the state of the vehicle or the hydraulic fluid, and may limit efficiency of the hydraulic system. The present disclosure provides a selective filtering system that may reduce pressure drop in the hydraulic system and improve overall system efficiency.

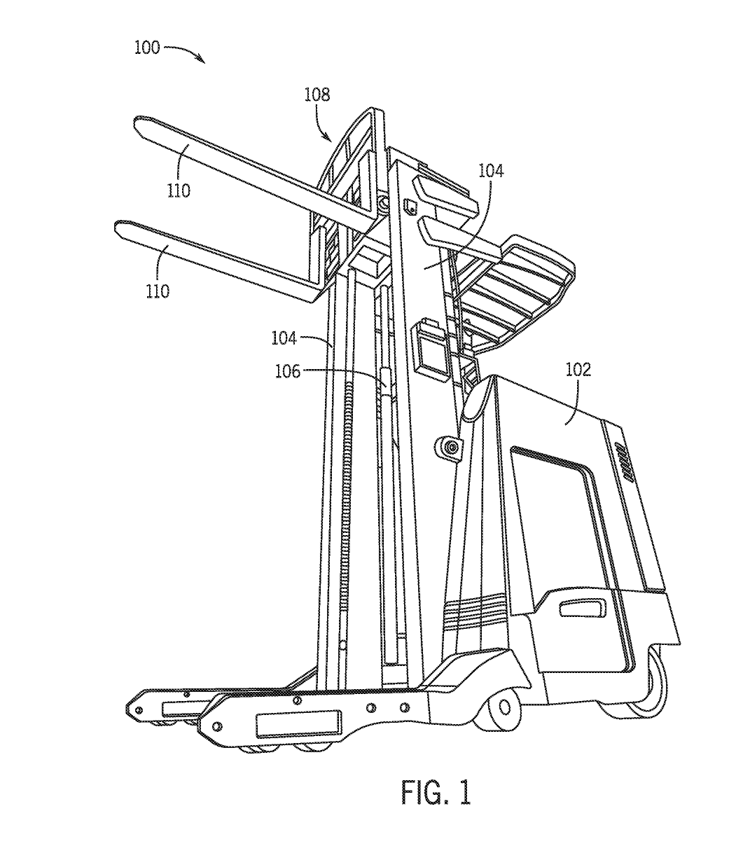

FIG. 1 illustrates one non-limiting example of a material handling vehicle (MHV) 100 in the form of a reach truck according to one non-limiting example of the present disclosure. The MHV 100 can include a base 102, a telescoping mast 104, one or more hydraulic actuators 106, and a fork assembly 108. The telescoping mast 104 can be coupled to the hydraulic actuators 106 such that the hydraulic actuators 106 can selectively extend or retract the telescoping mast 104. The fork assembly 108 can be coupled to the telescoping mast 104 so that when the telescoping mast 104 is extended or retracted, the fork assembly 108 can also be raised or lowered. The fork assembly 108 can further include one or more forks 110 on which various loads (not shown) can be manipulated or carried by the MHV 100.

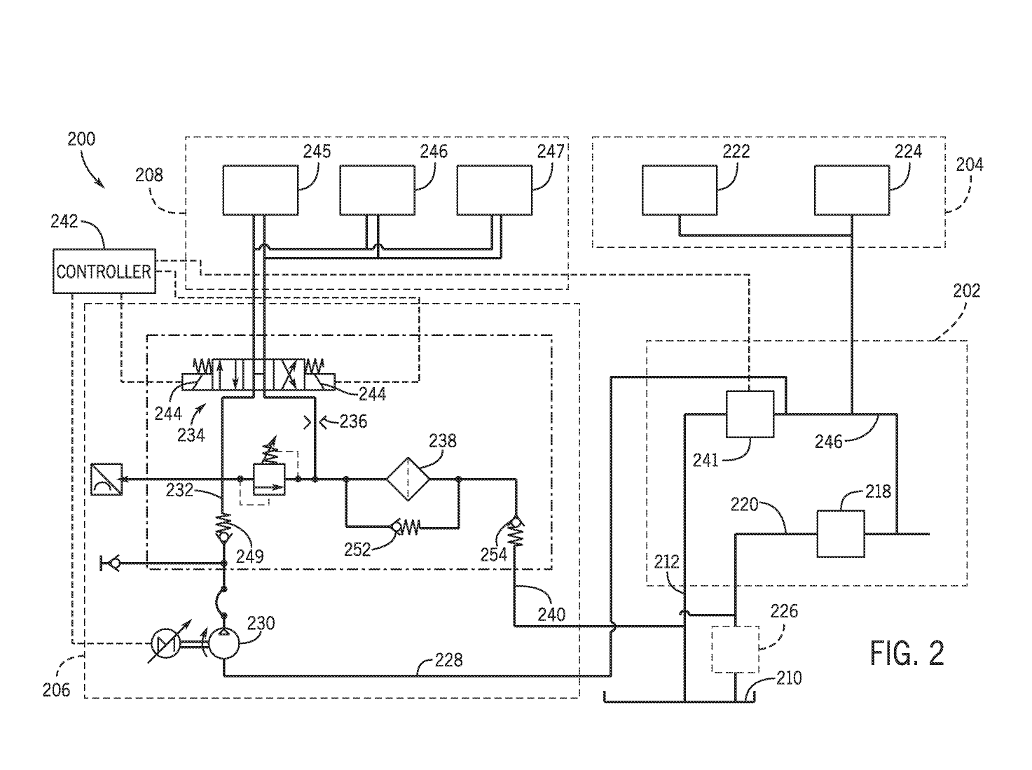

FIG. 2 illustrates one non-limiting example of a hydraulic system 200 that may be configured to provide selective filtration of hydraulic fluid within the hydraulic system 200, while controlling various components of the MHV 100. For example, an auxiliary polishing filter may be used when an auxiliary function is requested and/or any other time filtering can be opportunistically run when an auxiliary function is not being requested.

The hydraulic system 200 may include, but is not limited to, a primary circuit 202, primary function elements 204, an auxiliary filtering and hydraulic control circuit 206, auxiliary function elements 208, and a reservoir tank 210. The primary circuit 202 may include a primary supply line 212, a primary hydraulic pump 214, a primary pressurized passage 216, a flow restriction device 218, and a primary return line 220.

The primary hydraulic pump 214 may be configured to draw fluid, for example, hydraulic oil or any other suitable hydraulic fluid, from the reservoir tank 210, through the primary supply line 212, and furnish the hydraulic fluid at increased pressure at a primary pump outlet. The primary pump outlet may be in fluid communication with the primary pressurized passage 216. In some instances, the primary pressurized passage 216 may include any variety of additional selective flow devices (not shown), for example, a hydraulic manifold having a plurality of control valves, a plurality of relief valves, or any other suitable selective flow devices for a given application. The flow restriction device 218 may be configured to build pressure within the primary pressurized passage 216 before the hydraulic fluid flows back, through the primary return line 220, toward the reservoir tank 210. From the primary pressurized passage 216, the hydraulic system 200 may be configured to selectively apply the high pressure hydraulic fluid to the primary function elements 204. The primary function elements 204 may include a main lift cylinder 222 and a free lift cylinder 224, as non-limiting examples of hydraulic functions. The main lift cylinder 222 and the free lift cylinder 224 may be in the form of a piston-cylinder arrangement that is configured to raise or lower the telescoping mast 104, and thereby the fork assembly 108, via the hydraulic system 200.

In some instances, the primary return line 220 may include a high-flow filter 226. The high-flow filter 226 may be a highly porous filter and may be configured to filter out large impurities within the hydraulic fluid, without creating a high pressure differential between the inlet and the outlet of the high-flow filter 226. In some other instances, the primary return line 220 may not include the high-flow filter 226, and the primary return line 220 may be in direct fluid communication with the reservoir tank 210.

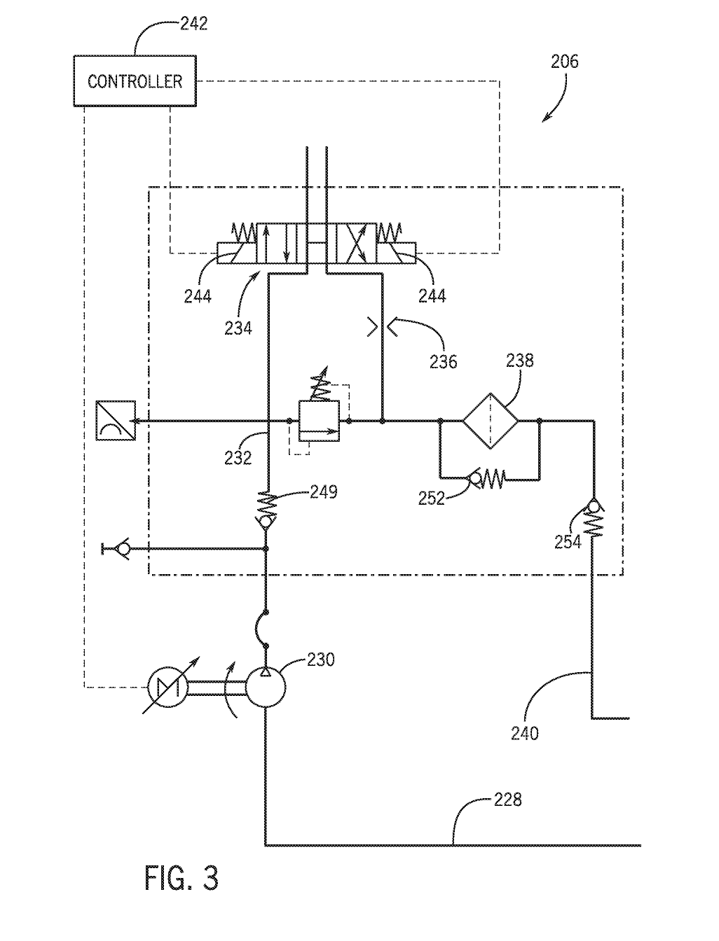

FIG. 3 illustrates one non-limiting example of the auxiliary filtering and hydraulic control circuit 206. The auxiliary filtering and hydraulic control circuit 206 may include an auxiliary supply line 228, an auxiliary hydraulic pump 230, an auxiliary pressurized passage 232, an auxiliary control valve 234, a flow restriction device 236, an auxiliary polishing filter 238, an auxiliary return line 240, and a controller 242.

The auxiliary hydraulic pump 230 may be in communication with the controller 242 and the auxiliary hydraulic pump 230 may be configured to draw hydraulic fluid from the reservoir tank 210, through the auxiliary supply line 228, and furnish the hydraulic fluid at an increased pressure at an auxiliary pump outlet. The auxiliary pump outlet may be in fluid communication with the auxiliary pressurized passage 232.

From the auxiliary pressurized passage 232, the auxiliary control valve 234 may be configured to selectively apply the hydraulic fluid from the auxiliary hydraulic pump 230 to the auxiliary function elements 208 (shown in FIG. 2) or bypass the auxiliary function elements 208, using auxiliary solenoids 244, which may each be in communication with the controller 242. The auxiliary function elements 208 (shown in FIG. 2) may comprise a reach element 245 (shown in FIG. 2), a side shift element 246 (shown in FIG. 2), a tilt element 247 (shown in FIG. 2), or any other desired auxiliary function element for a given operation. The flow restriction device 236 may be configured to build pressure and contain pressure surges within the auxiliary pressurized passage 232 prior to the hydraulic fluid flowing into the auxiliary polishing filter 238 and the auxiliary return line 240.

Once the hydraulic fluid flows through the flow restriction device 236, the hydraulic fluid may flow through auxiliary return line 240 and the auxiliary polishing filter 238, toward the primary return line 220 and the reservoir tank 210. The auxiliary polishing filter 238 can be configured to filter the hydraulic fluid as necessary for a given set of operating conditions. From the auxiliary polishing filter 238, the hydraulic fluid may flow through the auxiliary return line 240, into the primary return line 220, and further into the reservoir tank 210.

During operation, when an auxiliary function is commanded by an operator, the controller 242 may be configured to drive the auxiliary hydraulic pump 230 to force pressurized hydraulic fluid flow through check valve 249 toward the auxiliary control valve 234. The controller 242 may then be configured to operate the auxiliary control valve 234, using the auxiliary solenoids 244, to apply the pressurized hydraulic fluid to any of the auxiliary function elements 208, as necessary. From the auxiliary control valve 234, return flow of hydraulic fluid from the auxiliary function elements 208 may flow back through the auxiliary control valve 234, and back through the auxiliary return line 240 and the auxiliary polishing filter 238, and into the primary return line 220. Thus, when an auxiliary function operation is commanded, the hydraulic fluid may be drawn from the reservoir tank 210 and filtered by the auxiliary polishing filter 238.

Alternatively or additionally, if opportunity filtering is to be performed when an auxiliary operation is not being commanded, the controller 242 can actuate the auxiliary solenoids 244 to move the auxiliary control valve 234 to an open center position, which passes the flow of hydraulic fluid from the auxiliary hydraulic pump 230, through the auxiliary control valve 234, back through the auxiliary return line 240 and the auxiliary polishing filter 238. As such, regardless of an auxiliary function element 208 being utilized or not, in either instance, if the auxiliary hydraulic pump 230 is activated, the hydraulic fluid may be directed though the auxiliary polishing filter 238. In this way, for example, selective filtering of the hydraulic fluid in the hydraulic system 200 may occur, which provides a reduced system pressure drop when compared to continuous filtering performed in conventional systems.

In the illustrated non-limiting example, the auxiliary control circuit 206 includes a bypass check valve 250 and a return check valve 252. The bypass check valve 250 is arranged to enable fluid communication around the auxiliary polishing filter 238 (i.e., bypass the filter), when the filter is clogged or if pressure delta is too great for a given flow requirement. The return check valve 252 is arranged on the auxiliary return line 240 downstream of the filter 238 and is configured to prevent back flow into the auxiliary control circuit 206 if sufficient back pressure is built downstream of the return check valve 252 to divert flow toward the auxiliary control circuit 206.

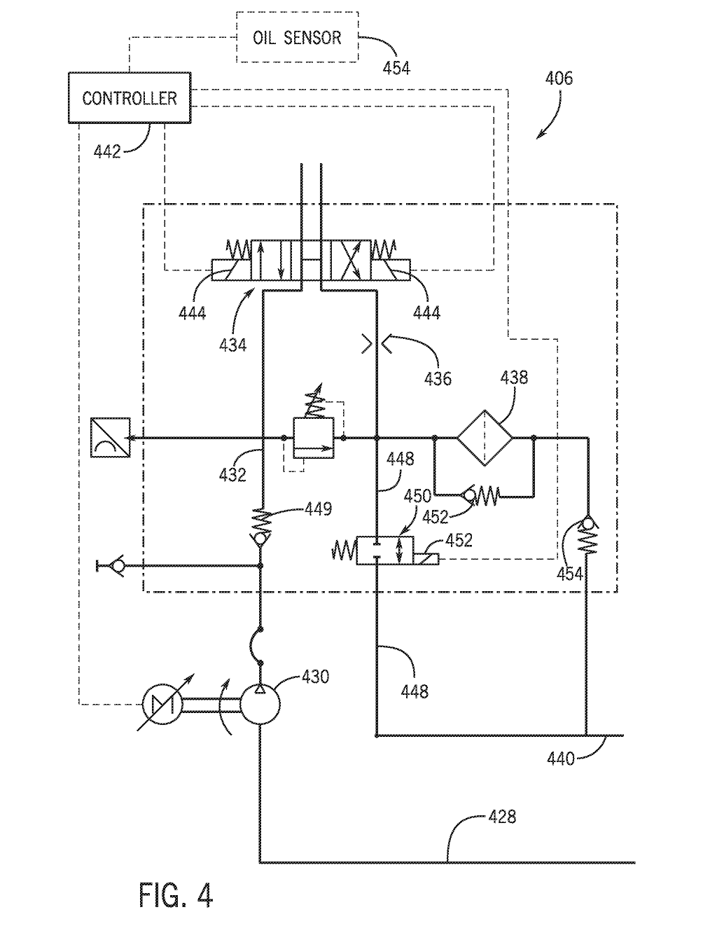

FIG. 4 illustrates another non-limiting example of an auxiliary filtering and hydraulic control circuit 406 according to the present disclosure. The auxiliary filtering and hydraulic control circuit 406 is substantially similar to the auxiliary filtering and hydraulic control circuit 206, with like elements being labeled similarly in the 400 series (e.g., auxiliary hydraulic pump 230 and auxiliary hydraulic pump 430, auxiliary polishing filter 238 and auxiliary polishing filter 438).

The auxiliary filtering and hydraulic control circuit 406 may further include a selective filter bypass passage 448 configured to selectively provide fluid communication from a point in the auxiliary return line 440 upstream of the auxiliary polishing filter 438 to a point in the auxiliary return line 440 downstream of the auxiliary polishing filter 438. The selective filter bypass passage 448 may include a selective bypass valve 450 operated by a bypass solenoid 452, which may be in communication with the controller 442.

Accordingly, during operation, the auxiliary filtering and hydraulic circuit 406 may operate substantially identical to the auxiliary filtering and hydraulic control circuit 206. However, the auxiliary filtering and hydraulic control circuit 406 may have the additional capability of selectively bypassing the auxiliary polishing filter 438 when the auxiliary hydraulic pump 430 is activated. For example, the controller 442 may actuate the bypass solenoid 452 to a position where fluid communication is provided along the selective filter bypass passage 448, which bypasses the auxiliary polishing filter 438 for predetermined amount of time. The amount of time to bypass the auxiliary polishing filter 438 may be determined using information regarding the truck performance and the particular truck application conditions. When filtering of the hydraulic fluid is desired, the controller 442 may actuate the bypass solenoid 452 to a positon where fluid communication is inhibited along the selective filter bypass passage 448, which forces fluid flow through the auxiliary polishing filter 438.

In some non-limiting examples, the auxiliary filtering and hydraulic control circuit 406 may additionally include at least one hydraulic fluid sensor 454 in communication with the controller 442. The at least one hydraulic fluid sensor 454 may comprise a light-based sensor based on light transmission (e.g., bubble and turbidity sensors), a sensor based on magnetic field effects (e.g., magnetic reluctance), a sensor based on electric field effects (e.g., a sensor that measures the dielectric properties of the hydraulic fluid), a sensor based on ultrasonic transmission, a sensor based on viscosity, a sensor based on density, a sensor based on temperature, or any other suitable sensor for determining desired characteristics of the hydraulic fluid. Accordingly, the hydraulic fluid sensor 454 may be used to actively monitor the hydraulic fluid condition and may also be used to drive the selective activation of the bypass solenoid 452. For example, if the hydraulic fluid sensor 454 provides an output indicative of the hydraulic fluid being at a state that does not require filtering, the controller 442 may instruct the bypass solenoid 452 to actuate to a position where fluid communication is provided along the selective filter bypass passage 448 and the auxiliary polishing filter 438 is bypassed. If the hydraulic fluid sensor 454 provides an output indicative of the hydraulic fluid requiring filtering, the controller 442 may instruct the bypass solenoid 452 to actuate to a position where fluid communication is inhibited along the selective filter bypass passage 448 and fluid is forced through the auxiliary polishing filter 438.

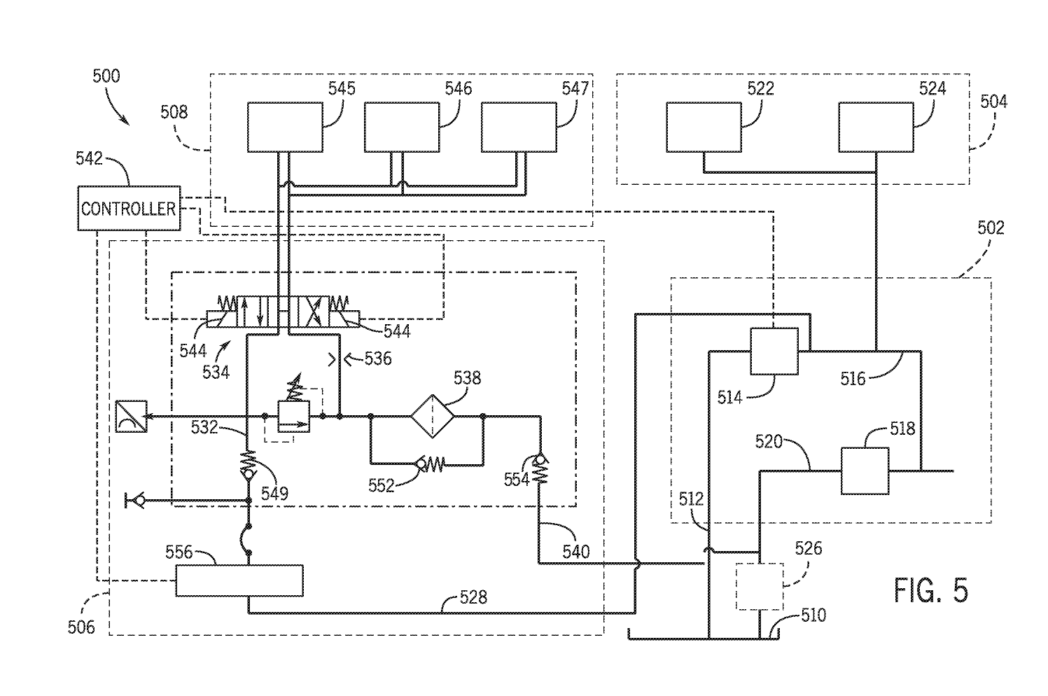

FIG. 5 illustrates another non-limiting example of a hydraulic system 500 that may be configured to provide selective filtration of hydraulic fluid within the hydraulic system 500, while controlling various components of the MHV 100. The hydraulic system 500 can be substantially similar to the hydraulic system 200, described above, with like elements being labeled similarly in the 500 series (e.g., auxiliary filtering and hydraulic control circuit 206 and auxiliary filtering and hydraulic control circuit 506, primary pressurized passage 216 and primary pressurized passage 516, etc.).

The auxiliary filtering and hydraulic control circuit 506 of the hydraulic system 500 may include an auxiliary supply line 528 that is in direct fluid communication with the primary pressurized passage 516 of the primary circuit 502. Additionally, the auxiliary filtering and hydraulic control circuit 506 may include a selective priority valve 556 instead of having an auxiliary hydraulic pump. The controller 542 may be in communication with the primary hydraulic pump 514, the auxiliary solenoids 544, and the selective priority valve 556.

In operation, the controller 542 may be configured to selectively run the primary hydraulic pump 514, thereby pressurizing the fluid within the primary pressurized passage 516. From the primary pressurized passage 516, the fluid can flow into the auxiliary supply line 528 toward the selective priority valve 556. The controller 542 can then be configured to selectively actuate the selective priority valve 556 to apply fluid through the auxiliary pressurized passage 532 to the rest of the auxiliary filtering and hydraulic control circuit 506. In some non-limiting examples, the selective priority valve 556 may be an on-off valve (e.g., a two-way, two-position valve) that either provides fluid flow therethrough or inhibits fluid flow therethrough). Thus, the selective priority valve 556 may be selective actuated to either provide fluid communication between the primary hydraulic pump 514 and the auxiliary pressurized passage 532, or inhibit fluid communication between the primary hydraulic pump 514 and the auxiliary pressurized passage 532.

Accordingly, during operation, the auxiliary filtering and hydraulic control circuit 506 may operate substantially identical to the auxiliary filtering and hydraulic control circuit 206, but instead of having a separate auxiliary hydraulic pump, both the primary circuit 502 and the auxiliary filtering and hydraulic control circuit 506 may be pressurized/operated using the same hydraulic pump (i.e., the primary hydraulic pump 514).

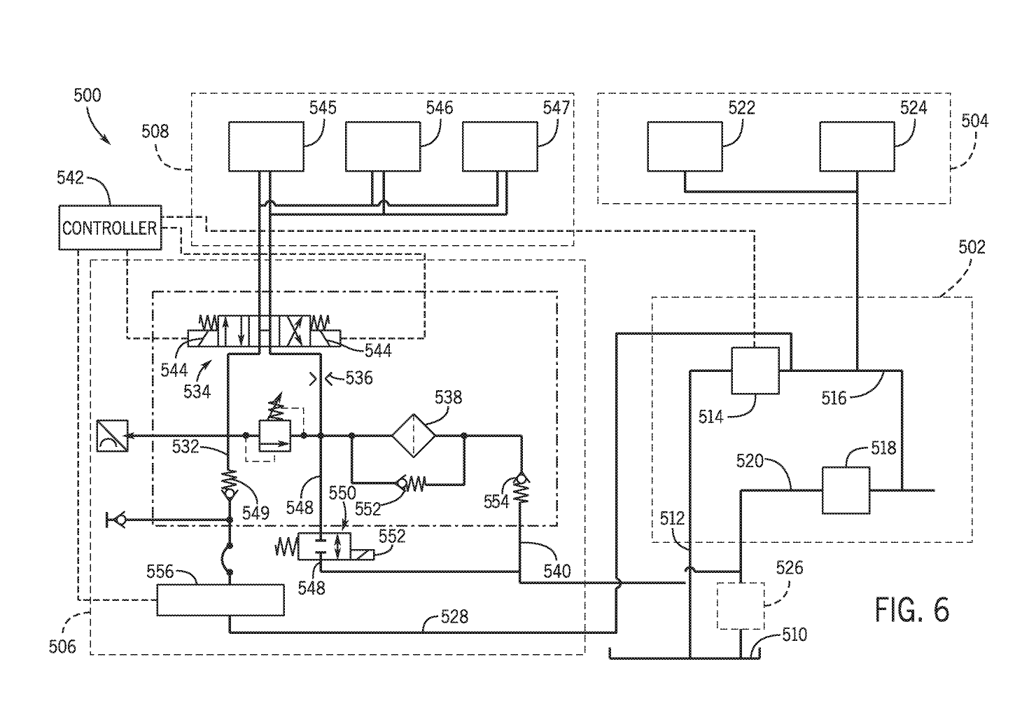

As illustrated in FIG. 6, a bypass passage 548 and bypass valve 550, similar to the selective filter bypass passage 448 and the selective bypass valve 450 of the auxiliary filtering and hydraulic control circuit 406, may additionally be implemented into the auxiliary filtering and hydraulic control circuit 506.

In some aspects, the hydraulic system 200 may use any of the auxiliary filtering and hydraulic control circuits 206, 406, 506 described herein to optimize performance and minimize regular maintenance downtime by selectively filtering hydraulic fluid during auxiliary truck functions, selectively filtering hydraulic fluid during load handling and non-load handling auxiliary operations, or performing any one of the aforementioned functions while additionally incorporating a hydraulic fluid sensor that may be used to actively monitor hydraulic fluid properties.

Cleanliness requirements of hydraulic components, filtering capability of a given filter element, wear rate of system hydraulic components, operating environment cleanliness, and the vehicle duty cycle of a given application may individually, or in conjunction with each other, be used to establish the hydraulic system design and/or to select hydraulic system components. By utilizing the auxiliary filtering and hydraulic control circuits 206, 406, 506 described herein, which provide the selective hydraulic fluid polishing (filtration), an evaluation may be performed using the aforementioned design criteria to determine when and how much hydraulic fluid flow may be necessary to flow through the filter element 238, 438 to optimize hydraulic efficiency, maximize performance capabilities, and optimize the maintenance cycle for changing the filter and changing the hydraulic fluid.

Utilization of this system may improve system performance by reducing pressure losses in the primary flow path (i.e., the primary circuit), reducing energy consumption by limiting the time hydraulic fluid is directed though the hydraulic fluid filter element, and minimizing regular maintenance downtime by evaluating information about the MHV and a given set of operational conditions and using that information to determine an optimized use of the filtering system for the MHV based on the operational conditions.

The disclosed system may further allow for reduced pressure losses in the primary circuit (the primary hydraulic flow path) that may otherwise potentially constrain hydraulic system design considerations and system performance (i.e., sizing and performance of pumps, regeneration systems, motor torques, etc.). The disclosed system may allow for improved energy efficiency by only activating the auxiliary filtering and hydraulic control circuit 206, 406, 506. For example, the disclosed system may provide improved efficiency based on application or environment by not filtering the system more than necessary to support an optimized vehicle maintenance interval.

The disclosed system allows for the removal of a filter from the primary circuit (the primary hydraulic flow path), which may allow for implementation of a smaller filter solution that has increased accessibility.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Thus, while the invention has been described in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

Various features and advantages of the invention are set forth in the following claims.

I claim:

1. A hydraulic system for a material handling vehicle comprising:
a reservoir tank;
a pump configured to draw fluid from the reservoir tank; and
an auxiliary circuit including an auxiliary filter, wherein the auxiliary circuit is in fluid communication with one or more auxiliary functions that are configured to receive fluid from the pump and return fluid to the reservoir tank,
wherein, when the one of the one or more auxiliary functions is commanded, fluid flow is provided from the pump to the reservoir tank through the auxiliary filter.

2. The hydraulic system of claim 1, wherein the pump is arranged in the auxiliary circuit.

3. The hydraulic system of claim 1, wherein the pump is arranged in a primary circuit, and wherein the primary circuit is in fluid communication within one or more primary functions.

4. The hydraulic system of claim 3, wherein, when one of the one or more primary functions is commanded, fluid flow is inhibited through the auxiliary filter.

5. The hydraulic system of claim 1, wherein the pump is arranged within the auxiliary circuit and the auxiliary circuit includes an auxiliary control valve configured to selective provide fluid communication between the between the one or more auxiliary functions, the pump, and the reservoir tank.

6. The hydraulic system of claim 5, wherein the auxiliary control valve includes an open center position.

7. The hydraulic system of claim 6, wherein, when the control valve is selectively actuated to the open center position, fluid flow is provided from the pump to the reservoir tank through the auxiliary filter.

8. The hydraulic system of claim 1, wherein the auxiliary circuit includes a bypass solenoid configured to selectively provide fluid communication along a bypass passage and allow fluid to bypass the auxiliary filter.

9. A hydraulic system for a material handling vehicle comprising:
a reservoir tank; and
an auxiliary circuit including an auxiliary filter, an auxiliary pump, an auxiliary control valve, a bypass passage, and a bypass solenoid arranged on the bypass passage, wherein the auxiliary control valve is configured to selectively provide fluid communication between the auxiliary pump, the reservoir tank, and one or more auxiliary functions, and wherein the bypass solenoid is configured to selectively provide or inhibit fluid communication along the bypass passage, and
wherein, when the auxiliary pump is activated to provide fluid flow and the bypass solenoid inhibits fluid communication along the bypass passage, fluid flow is provided from the auxiliary pump to the reservoir tank through the auxiliary pump.

10. The hydraulic system of claim 1, wherein, when the auxiliary pump is activated to provide fluid flow and the bypass solenoid provides fluid communication along the bypass passage, fluid flow bypasses the auxiliary filter and is provided from the auxiliary pump to the reservoir tank.

11. The hydraulic system of claim 9, further comprising a primary circuit including a primary pump, and wherein the primary circuit is in fluid communication within one or more primary functions.

12. The hydraulic system of claim 11, wherein, when one of the one or more primary functions is commanded, fluid flow is inhibited through the auxiliary filter.

13. The hydraulic system of claim 9, wherein the bypass valve is selectively actuated to inhibit or provide fluid flow along the bypass passage in response to an output from a hydraulic fluid sensor configured to measure a fluid condition.

14. A hydraulic system for a material handling vehicle comprising:
a reservoir tank;
a primary circuit including a primary pump configured to provide fluid flow to one or more primary functions;
an auxiliary circuit including and an auxiliary filter, wherein the auxiliary circuit is in fluid communication with one or more auxiliary functions; and
an auxiliary supply line configured to provide fluid communication between the primary pump and the auxiliary circuit, and
wherein, when one of the one or more auxiliary functions is commanded, fluid flow is provided from the primary pump to the reservoir tank through the auxiliary filter.

15. The hydraulic system of claim 14, wherein, when one of the one or more primary functions is commanded, fluid flow is inhibited through the auxiliary filter.

16. The hydraulic system of claim 14, wherein the auxiliary circuit includes a bypass solenoid configured to selectively provide fluid communication along a bypass passage and allow fluid to bypass the auxiliary filter.

17. The hydraulic system of claim 14, wherein the auxiliary circuit includes a selective priority valve that is configured to selectively provide or inhibit fluid communication between the primary pump and the auxiliary circuit.

18. The hydraulic system of claim 17, wherein the auxiliary circuit includes an auxiliary control valve configured to selective provide fluid communication between the between the one or more auxiliary functions, the pump, and the reservoir tank.

19. The hydraulic circuit of claim 18, wherein the auxiliary control valve includes an open center position.

20. The hydraulic system of claim 19, wherein, when the selective priority valve provides fluid communication between the pump and the auxiliary circuit, fluid flow is provided from the pump to the reservoir tank through the auxiliary filter.
